(19) United States
(12) Patent Application Publication
(10) Pub. No.: US 2010/0052868 A1
(43) Pub. Date: Mar. 4, 2010

(54) Apparatus for Providing Mail Message and Electronic Multimedia Content, Electronic Apparatus for Accessing Electronic Multimedia Content and Method Thereof

(75) Inventor: Chia-Hsien Lin, Hsinchu Hsien (TW)

Correspondence Address: EDELL, SHAPIRO & FINNAN, LLC, 1901 RESEARCH BOULEVARD, SUITE 400, ROCKVILLE, MD, 20850, US

(73) Assignee: MSTAR SEMICONDUCTOR, INC., Hsinchu Hsien (TW)

(21) Appl. No.: 12/546,113

(22) Filed: Aug. 24, 2009

(30) Foreign Application Priority Data
Sep. 3, 2008 (TW) 097133717

(51) Int. Cl. H04Q 5/00

(52) U.S. Cl. 340/10.51; 709/217

(57) ABSTRACT

An electronic apparatus for accessing an electronic multimedia content is provided. The electronic apparatus includes a radio frequency identification (RFID) reader and a transmitting circuit. The RFID reader is used for accessing network link information stored in an RFID tag attached to an object. The transmitting circuit is coupled to the RFID reader and downloads the electronic multimedia content via the Internet according to the network link information.

### CROSS REFERENCE TO RELATED PATENT APPLICATION

This patent application is based on Taiwan, R.O.C. patent application No. 097133717 filed on Sep. 3, 2008.

### FIELD OF THE INVENTION

The invention relates to an electronic identification mechanism, and more particularly, to an apparatus used for mail and a method thereof.

### BACKGROUND OF THE INVENTION

As the Internet continues to develop, communication between people via electronic mail or electronic cards is becoming increasingly popular. Electronic mail or electronic cards, being low-cost, are delivered immediately and have contents that can be expressed in a lively manner in electronic multimedia of various forms, such as voices, images or motion pictures. However, compared to the real world, the virtual world lacks reality is can be rather emotionless. Hence a natural need for physical mail and cards still exists. For example, when people receive an article of mail, e.g., a handwritten scenery postcard, the feeling is different from the feeling of accessing electronic multimedia content. As a result, under some special circumstances, people still would like to have the option of a handwritten mail or card to communicate with each other.

When a handwritten article of mail or card with an image and audio from a friend or a family member is received, a sensory feeling of hearing a wish or visualizing an image of the sender is likely more intense. However, to directly combine multimedia content with an article of mail or a card, one is faced with many technicality difficulties.

### SUMMARY OF THE INVENTION

One objective of the present invention is to provide a radio frequency identification (RFID) technology and mail associated with the RFID technology. When a recipient is reading physical mail, an image or a voice provided by the sender can be perceived visually or by hearing as well, thereby solving the problem mentioned above.

According to an embodiment of the present invention, an apparatus for providing a mail message and electronic multimedia content is provided. The apparatus comprises a body and an RFID tag. The mail is used for recording the mail message, and the RFID tag is attached to the body and is used for storing network link information corresponding to the electronic multimedia content. When the RFID tag is read by an RFID reader of the electronic apparatus, the RFID reader of the electronic apparatus downloads the electronic multimedia content via the Internet according to the network link information stored in the RFID tag.

According to another embodiment of the present invention, an electronic apparatus for accessing an electronic multimedia content is provided. The apparatus comprises an RFID reader and a transmitting circuit. The RFID reader is used for accessing network link information stored in an RFID tag attached to an object. The transmitting circuit is coupled to the RFID reader, and is used for downloading the electronic multimedia content via the Internet according to the network link information.

According to another embodiment of the present invention, a method of accessing an electronic multimedia content is provided. The method comprises steps of accessing network link information stored in an RFID tag attached to an object, and downloading the electronic multimedia content via the Internet according to the network link information.

### BRIEF DESCRIPTION OF THE DRAWINGS

FIG. 1 is a schematic diagram of a system according to an embodiment of the present invention.

FIG. 2 is a schematic diagram of a system according to another embodiment of the present invention.

### DETAILED DESCRIPTION OF THE PREFERRED EMBODIMENT

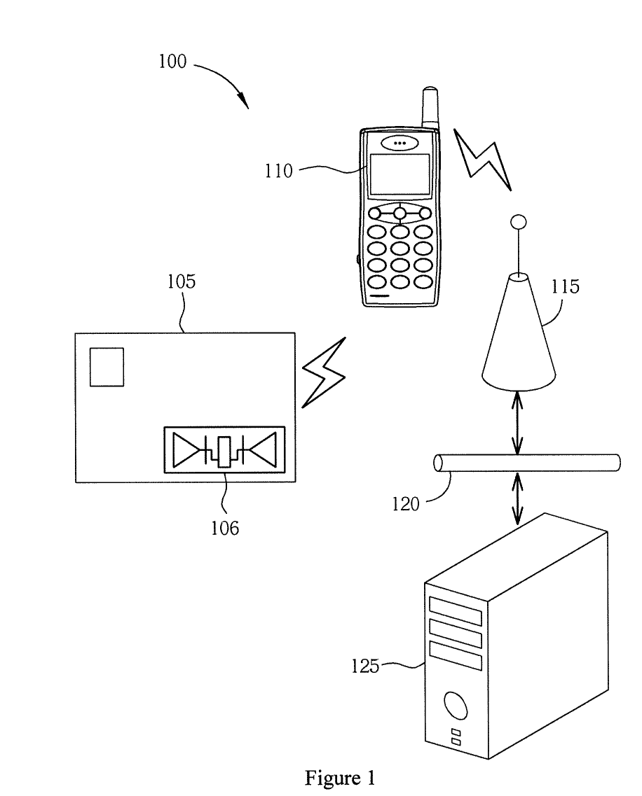

FIG. 1 shows a schematic diagram of a system 100 according to an embodiment of the present invention. The system 100 comprises an apparatus 105 including a mail message and link information corresponding to electronic multimedia content, an electronic apparatus 110, a wireless base station 115, a wired network 120 and a remote server 125. The apparatus 105 is an object capable of being mailed, such as a postcard, a greeting card, a writing paper, an envelope and so on. In this embodiment, the apparatus 105 is a postcard. In addition to the mail message recorded on the body of the postcard 105, an RFID tag 106 is attached or secured to, or embedded in the body of the postcard 105. The RFID tag 106 has a unique identification code, such as an electronic product code (EPC), and is used for storing the network link information corresponding to electronic multimedia content, such as an Internet address. The electronic multimedia content is stored in a multimedia video database of the remote server 125.

The electronic apparatus 110 is a portable apparatus or a fixed electronic apparatus. The portable device can be a mobile phone, a personal digital assistant (PDA) or a laptop, and the fixed electronic apparatus can be a desktop computer. In this embodiment, the electronic apparatus 110 is a mobile phone. More specifically, the electronic apparatus 110 comprises an RFID reader and a transmitting circuit. The RFID reader is used for accessing the identification code of the RFID tag 106 of the postcard 105 and the network link information stored in the RFID tag 106. The transmitting circuit is coupled to the RFID reader and is used for downloading the electronic multimedia content via the Internet according to the network link information. The Internet used in the electronic apparatus 110 may be wireless network. For example, referring to FIG. 1, the wireless base station 115 is connected to the remote server 125 via the wired network 120. The wireless base station 115 implements a communication protocol such as 3G, WLAN or WiMAX, and the transmitting circuit also has a corresponding wireless communication protocol to transmit data to the wireless base station 115.

With respect to an application of the present invention, for example, when a traveler sends a local scenery postcard to his family or friends, he wishes his family or friends to watch a video or hear sounds recorded at his travel location in addition to reading handwritten characters when the postcard is received. In order to meet the traveler's demand, the scenery postcard with an RFID tag, such as the apparatus 105 according to the present invention, is provided. Therefore, when the traveler purchases the scenery postcard to write down his greetings, he can further upload the recorded electronic content to the multimedia video database of the remote server 125 via a network such as a wired network or a wireless network. The RFID tag 106 has a special and unique identification code. Hence when the electronic multimedia content is uploaded, the traveler enters the identification code of the RFID tag 106, and the remote server 125 connects the identification code to the electronic multimedia content. When the postcard 105 is sent to a family member or a friend via a post system, by using the RFID reader of the foregoing electronic apparatus 110 for accessing the Internet address stored in the RFID tag 106, and the identification code of the RFID tag 106, as well as the transmitting circuit connects to the multimedia video database of the remote server 125 according to the Internet address via the wireless base station 115 and the wired network 120, the family member or the friend can access the electronic multimedia content according to the identification code of the RFID tag 106. Thus, not only are the handwritten characters of the traveler received, but local scenery may also be seen or the voice of the traveler heard by the recipient. The RFID tag 106 may be provided on the card, the writing paper or the envelope; alternatively, the apparatus 105 may be one of the card, the writing paper and the envelope, as also being encompassed within the scope of the present invention. In addition, when the mentioned network link information is information corresponding to an Internet address, rather than being the Internet address, the electronic apparatus 110 implements database software to connect to the remote server 125 by way of setting the information of the RFID tag 106 as an index of the Internet address of the remote server 125.

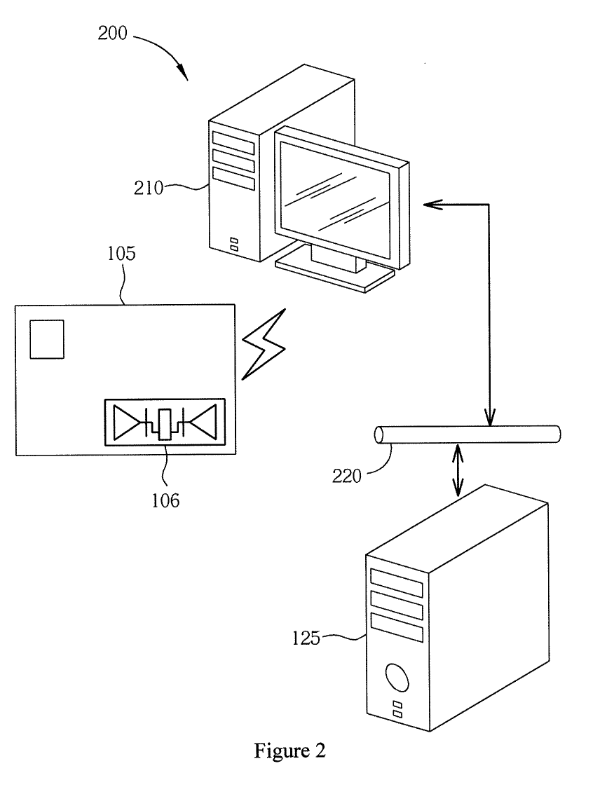

In addition, the portable apparatus and the wireless network are not limited as a sole means for downloading the traveler's electronic multimedia content according to the present invention. For example, a personal computer may also be used for downloading the electronic multimedia content. FIG. 2 shows a schematic diagram of a system 200 in accordance with another embodiment of the present invention. The main difference between the system 100 and the system 200 is an electronic apparatus 210 such as a personal computer, which, in the system 200, is used for connecting a wired network 220 to the remote server 125 and downloading the electronic multimedia content from the video database of the remote server 125. At the same time, a transmitting circuit of the electronic apparatus 210 has a corresponding line communication protocol to transmit data via the wired network 220.

In conclusion, RFID technology is applied to mail articles according to the present invention, to provide enhanced services for optimizing people's living quality and increasing user convenience. Regardless of whether sending a letter, a card or a postcard, according to the invention, a sender may purchase a writing paper, an envelope, a card or a postcard with the RFID tag, and write on the writing paper, the envelope, the card or the postcard. The sender may further upload an electronic multimedia content not necessarily recorded by the sender to the database of the remote server according to an identification code of the RFID tag. The RFID is used for storing the network link information of the remote server. As a result, when the letter, the greeting card or the postcard is received, an electronic apparatus having an Internet function and an RFID reading function is used for accessing the network link information and the identification code and downloading the electronic multimedia content from the database of the remote server according to the network link information and the identification code. The recipient can thus read the static characters written by the sender, watch a dynamic video and hear voices and sounds. The electronic apparatus may be a portable apparatus such as a mobile phone or a PDA, or a fixed electronic apparatus such as a desktop computer or a television with an RFID reading function. However, the foregoing examples shall not be construed as limiting. Moreover, the RFID tag is low-cost and the mobile phone is widely used.

In addition, a readable/writeable non-volatile memory, such as a flash memory, is directly built inside the article of mail. Considering not adding more weight or volume to the mail, a non-volatile memory is used for directly storing the electronic multimedia content or data content. In other words, a content of a video, a photo, a voice or a data need not be uploaded to the database of the remote server 105 by the user, but is directly stored into the non-volatile memory. Hence when the mail is received, the RIFD reader of the electronic apparatus may be used for reading the content, such that the multimedia/data content is accessible by the electronic apparatus without Internet function. Two manners, namely accessing the electronic multimedia/information content from the remote server 105 and directly accessing the electronic multimedia/information content from the non-volatile memory built in the mail, could be provided concurrently. For example, referring to FIG. 1, the apparatus 105 according to another embodiment further comprises a non-volatile memory. When the two manners of accessing the electronic/information content from the remote server 125 and from the non-volatile memory are provided, the access sequence is designed according to user preferences. In addition, referring to FIG. 2, the apparatus 105 according to another embodiment further comprises a non-volatile memory. When two manners of accessing the electronic/information content from the remote server 125 and from the non-volatile memory are provided, how a personal computer 210 accesses the electronic/information content is designed according to user preferences as well. Note that the embodiments mentioned above match with the spirit of the present invention.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. An apparatus for providing a mail message and an electronic multimedia content, comprising:
a body, for recording the mail message; and
a radio frequency identification (RFID) tag, attached to the body, for storing network link information corresponding to the electronic multimedia content;
wherein the RFID tag comprises information that is accessible by an RFID reader of an electronic apparatus and that is sufficient to permit the electronic apparatus to download the electronic multimedia content via the Internet according to the network link information stored in the RFID tag.

2. The apparatus as claimed in claim 1, wherein the apparatus is one of an envelope, writing paper, a postcard and a greeting card.

3. The apparatus as claimed in claim 1, wherein the network link information is an Internet address.

4. An electronic apparatus for accessing electronic multimedia content, comprising:
an RFID reader, for accessing network link information stored in an RFID tag attached to an object; and
a transmitting circuit, coupled to the RFID reader, for downloading the electronic multimedia content via the Internet according to the network link information.

5. The electronic apparatus as claimed in claim 4, wherein the object is one of an envelope, writing paper, a postcard and a greeting card.

6. The electronic apparatus as claimed in claim 4, wherein the network link information is an Internet address.

7. The electronic apparatus as claimed in claim 6, wherein the electronic multimedia content is stored in a remote server, and the electronic apparatus further downloads the electronic multimedia content by connecting to the remote server according to the Internet address.

8. The electronic apparatus as claimed in claim 4, wherein the electronic apparatus is a portable device capable of downloading the electronic multimedia via a wireless network.

9. A method for accessing an electronic multimedia content, comprising steps of:
accessing network link information stored in an RFID tag; and
downloading the electronic multimedia content via the Internet according to the network link information.

10. The method as claimed in claim 9, wherein the object is one of an envelope, writing paper, a postcard or a greeting card.

11. The method as claimed in claim 9, wherein the network link information is an Internet address.

12. The method as claimed in claim 9, wherein the electronic multimedia content is stored in a remote server, the network link information is an Internet address, and the step of downloading the electronic multimedia content via the Internet address according to the network link information further comprises a step of downloading the electronic multimedia content by connecting to the remote server according to the Internet address.

13. The method as claimed in claim 12, wherein the step of downloading the electronic multimedia content via the Internet according to the Internet address, further comprises a step of downloading the electronic multimedia content via a wireless network according to the Internet address.
